(19) United States
(12) Patent Application Publication
(10) Pub. No.: US 2016/0133917 A1
(43) Pub. Date: May 12, 2016

(54) METHOD OF FABRICATING CATHODE FOR THIN FILM BATTERY USING LASER, CATHODE FABRICATED THEREBY, AND THIN FILM BATTERY INCLUDING THE SAME

(71) Applicant: Korea Institute of Science and Technology, Seoul (KR)

(72) Inventors: Ji-Won CHOI, Seoul (KR); Seok Jin YOON, Seoul (KR); Jin Sang KIM, Seoul (KR); Chong Yun KANG, Seoul (KR); Seung Hyub BAEK, Seoul (KR); Seong Keun KIM, Seoul (KR); Beomjin KWON, Seoul (KR); Haena YIM, Seoul (KR)

(73) Assignee: Korea Institute of Science and Technology, Seoul (KR)

(21) Appl. No.: 14/802,715

(22) Filed: Jul. 17, 2015

(30) Foreign Application Priority Data
Nov. 6, 2014 (KR) 10-2014-0153627

(51) Int. Cl. H01M 4/04; H01M 10/659; H01M 4/58; H01M 10/04; H01M 4/525; H01M 4/505

(52) U.S. Cl. CPC H01M 4/0402; H01M 4/0404; H01M 4/525; H01M 4/505; H01M 4/5825; H01M 10/0436; H01M 10/659; H01M 2004/028

(57) ABSTRACT

A method of fabricating a cathode for a thin film battery includes depositing a cathode active material on a substrate, and crystallizing the cathode active material by irradiating laser onto the cathode active material. The cathode active material may be deposited on the substrate at normal temperature, and a light and easily processable polymer substrate may be used by crystallizing the cathode active material at low temperature using laser. A thin film battery including the cathode fabricated by the above method has excellent charging/discharging characteristics such as high discharge capacity.

### CROSS-REFERENCE TO RELATED APPLICATION

This application claims priority to Korean Patent Application No. 10-2014-0153627, filed on Nov. 6, 2014, and all the benefits accruing therefrom under 35 U.S.C. §119, the contents of which in its entirety are herein incorporated by reference.

### BACKGROUND

1. Field

Embodiments relate to a method of fabricating a cathode for a thin film battery, a cathode fabricated by the method, and a thin film battery including the same, and more particularly, to a method of crystallizing a cathode film at low temperature by using laser.

2. Description of the Related Art

A lithium ion thin film battery is being more frequently used for portable electronic devices, an energy source of micro electro mechanical systems (MEMS), a power source of sensors, future micro robot industries, or the like due to an excellent energy density, a non-memory effect due to a low self-discharging rate, and a high operating voltage.

Meanwhile, along with the rapid development of information technologies and the beginning of ubiquitous era, flexible device industries such as flexible displays, flexible electronic devices or the like are growing. A lithium thin film battery should satisfy various features such as light weight, low power, flexibility, elasticity, etc. in order to be applied to such a next-generation electronic device.

Recently, in order to realize a flexible electronic device industry, various flexible substrates such as a flexible glass, a metallic foil, a polymer substrate, an ultra-thin glass, etc. are applied. Among them, the polymer substrate is the most frequently studied for flexible devices and ensures light weight and easy processing in comparison to other kinds of substrates. For this reason, the polymer substrate has no limit in its shape and also ensures unlimited applications. Therefore, a lot of studies are being carried out to implement a thin film battery with the polymer substrate.

A lithium thin film battery includes a cathode current collector, a cathode, a solid electrolyte, an anode and an anode current collector. The cathode active material determines a capacity of the thin film. A thin film should have excellent crystalline characteristics in order to ensure easy movement of lithium ions. Therefore, in order to realize a battery with excellent battery characteristics, it is essential to perform a crystallization process by thermally treating the deposited active material. However, in case of the polymer substrate, the substrate is expanded and shrunken due to thermal treatment, which may form a crack in the thin film. In addition, due to low thermal resistance of the substrate, it may be significantly damaged.

### SUMMARY

An embodiment of the present disclosure provides a flexible lithium thin film battery, which may not have any problems such as substrate expansion, shrinkage or cracking due to a thermal treatment process for crystallizing a cathode film even though a polymer substrate is used for manufacturing the lithium thin film battery.

In one aspect, there is provided a method of fabricating a cathode for a thin film battery, which includes: depositing a cathode active material on a substrate; and crystallizing the cathode active material by irradiating laser onto the cathode active material.

The laser may be excimer laser.

The excimer laser may use a KrF or ArF source.

In the depositing of the cathode active material onto the substrate, the cathode active material may be deposited at normal temperature.

The substrate may be a metallic substrate, a polymer substrate or a ceramic substrate.

The crystallizing of the cathode active material by irradiating laser onto the cathode active material may include irradiating light to the cathode active material during several nanoseconds.

The crystallizing of the cathode active material by irradiating laser onto the cathode active material may include irradiating light having an energy equal to or greater than 1 mJ/cm² and smaller than 200 mJ/cm² to the cathode active material.

The crystallizing of the cathode active material by irradiating laser onto the cathode active material may include irradiating light to the cathode active material as many as 1 to 2000 shots.

The laser may be excimer laser using a KrF source, and the crystallizing of the cathode active material by irradiating laser onto the cathode active material may include irradiating light to the cathode active material as many as 500 to 2000 shots.

The method of fabricating a cathode for a thin film battery may further include forming a buffer layer on the substrate, before the depositing of the cathode active material onto the substrate.

The buffer layer may be made of silicon nitride or silicon oxide.

The method of fabricating a cathode for a thin film battery may further include depositing a cathode current collector on the substrate, before the depositing of the cathode active material onto the substrate.

The cathode active material may be at least one selected from the group consisting of LiNi_{0.5}Mn_{1.5}O₄, LiMn₂O₄, M-doped LiMn₂O₄, Li(MnNiCo)O₂, LiCoO₂ and LiMPO₄ (M is a transition metal).

In the depositing of the cathode active material onto the substrate, the cathode active material may be deposited as thick as several ten nanometers to several micrometers.

In another aspect of the present disclosure, there is provided a cathode for a thin film battery, which is fabricated by the above method of fabricating a cathode for a thin film battery.

In another aspect of the present disclosure, there is provided a thin film battery, which includes: a substrate; a cathode current collector formed on the substrate; a cathode formed on the cathode current collector; an electrolyte layer formed on the cathode; and an anode formed on the electrolyte layer, wherein the substrate is made of polymer material.

In the thin film battery, one surface of the cathode may be in direct contact with one surface of the cathode current collector.

The thin film battery may further include a buffer layer formed between the substrate and the cathode.

The buffer layer may serve as a thermal cutoff layer for preventing a heat transfer from the cathode to the substrate.

The buffer layer may be made of silicon nitride or silicon oxide.

The cathode may be fabricated by the above method of fabricating a cathode for a thin film battery.

The thin film battery may further include an electrolyte layer formed between the cathode and the anode.

The thin film battery may further include a barrier film layer formed on the anode to prevent oxidation of the thin film battery.

If the method of fabricating a cathode for a thin film battery according to an embodiment of the present disclosure, a cathode fabricated thereby, and a thin film battery including the same are employed, a cathode active material may be crystallized within a short time without damaging the substrate by heat, and thus it is possible to apply a polymer substrate, realize excellent charging/discharging characteristics such as a high discharge capacity, and extend a life cycle of the battery.

In addition, according to an embodiment of the present disclosure, when a cathode film is crystallized on the polymer substrate at low temperature, a flexible thin film battery in an all solid state may be fabricated on a polymer substrate with low thermal resistance without transcription.

### BRIEF DESCRIPTION OF THE DRAWINGS

FIG. 1 is a flowchart for illustrating a method of fabricating a cathode for a thin film battery according to an embodiment of the present disclosure.

FIG. 2 is a diagram for illustrating a process of fabricating a thin film battery according to an embodiment of the present disclosure.

FIG. 3 is a cross-sectional view of a thin film battery according to an embodiment of the present disclosure.

FIG. 4 is a graph showing an X-ray diffraction pattern of a cathode according to an embodiment of the present disclosure depending on laser energy.

FIG. 5 is a photograph of a scanning electron microscope of the cathode of FIG. 4.

FIG. 6a shows an X-ray diffraction pattern of a cathode according to an embodiment of the present disclosure depending on a laser irradiation shot number.

FIG. 6b is a photograph of a differential scanning microscope of the cathode depicted in FIG. 6a depending on a laser irradiation shot number.

FIG. 7 shows a table and a graph showing electrochemical characteristics of a thin film battery according to an embodiment of the present disclosure depending on laser energy.

FIGS. 8a to 8c are graphs showing electrochemical characteristics of thin film batteries according to embodiments of the present disclosure depending on a laser irradiation shot number.

FIG. 9a is a photograph of a scanning electron microscope of the cathode of the present example.

FIG. 9b is an X-ray diffraction pattern of the cathode prepared according to Example 3.

### DETAILED DESCRIPTION

The terminology used herein is for the purpose of describing particular embodiments only and is not intended to be limiting the present disclosure. In the description, details of well-known features and techniques may be omitted to avoid unnecessarily obscuring the presented embodiments. In the drawings, like reference numerals denote like elements. The shape, size and regions, and the like, of the drawings may be exaggerated for clarity.

Hereinafter, embodiments of the present disclosure will be described in detail with reference to the accompanied drawings.

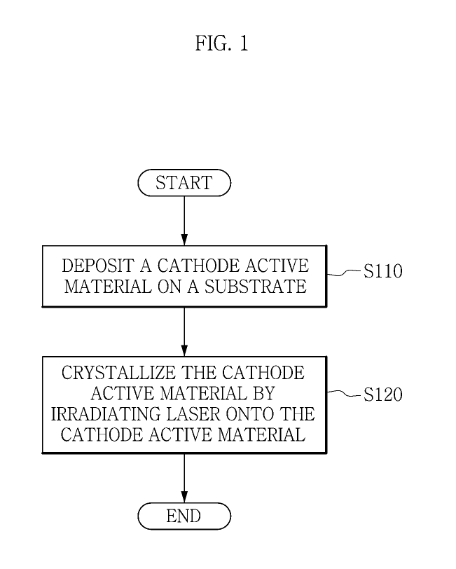

FIG. 1 is a flowchart for illustrating a method of fabricating a cathode for a thin film battery according to an embodiment of the present disclosure. Referring to FIG. 1, a method of fabricating a cathode for a thin film battery may include depositing a cathode active material on a substrate (S110), and crystallizing the cathode active material by irradiating laser onto the cathode active material (S120).

Since laser is used for crystallizing the cathode active material, the cathode active material may be crystallized more rapidly and more simply in comparison to an existing crystallization method in which a thin film is heated. In addition, the cathode active material may be crystallized at low temperature below 250° C. at which a polymer substrate made of polyimide or the like is not deformed. Thereby, it is possible to ensure excellent charging/discharging characteristics, high discharge capacity, and increased battery life span at the same time.

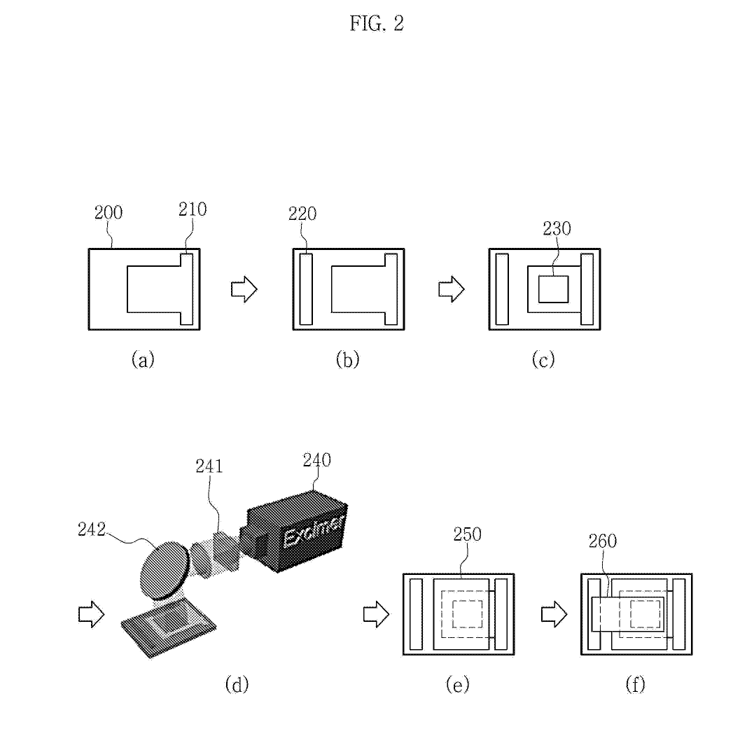

Hereinafter, a method for fabricating a thin film battery will be described in detail with reference to FIG. 2, based on the method of fabricating a cathode for a thin film battery according to an embodiment of the present disclosure.

As shown in FIG. 2(a), a cathode current collector 210 is first deposited to a substrate 200 by means of DC magnetron sputtering or the like.

The substrate 200 is not limited as long as a cathode thin film can be formed thereon, and may be selected from a ceramic substrate, a thermal-resisting polymer substrate, a metallic substrate and the like. For example, the substrate 200 may be made of silicon (Si) or sapphire with excellent thermal resistance as well as paper or polymer materials such as polyimide with low thermal resistance, poly ethylene terephthalate (PET), etc.

The cathode current collector 210 is made of material with excellent conductivity such as platinum (Pt), aluminum (Al), gold (Au), silver (Ag), indium tin oxide (ITO) or the like. The cathode current collector 210 may have various shapes, and for example, the cathode current collector 210 may have a rectangular, square or circular cross-section.

In order to prevent a thermal impact against the substrate 200 when laser is irradiated to the cathode active material later, before the cathode current collector 210 is deposited, a buffer layer for preventing a temperature rise of the substrate by reducing heat transfer from the cathode active material to the substrate may be further deposited. A thin film made of material with high thermal short resistance or a thin film with low thermal diffusivity may be formed on the substrate in advance as the buffer layer.

In addition, in order to improve adhesion at an interface, an interface adhesion layer may be further deposited before the cathode current collector 210 is deposited.

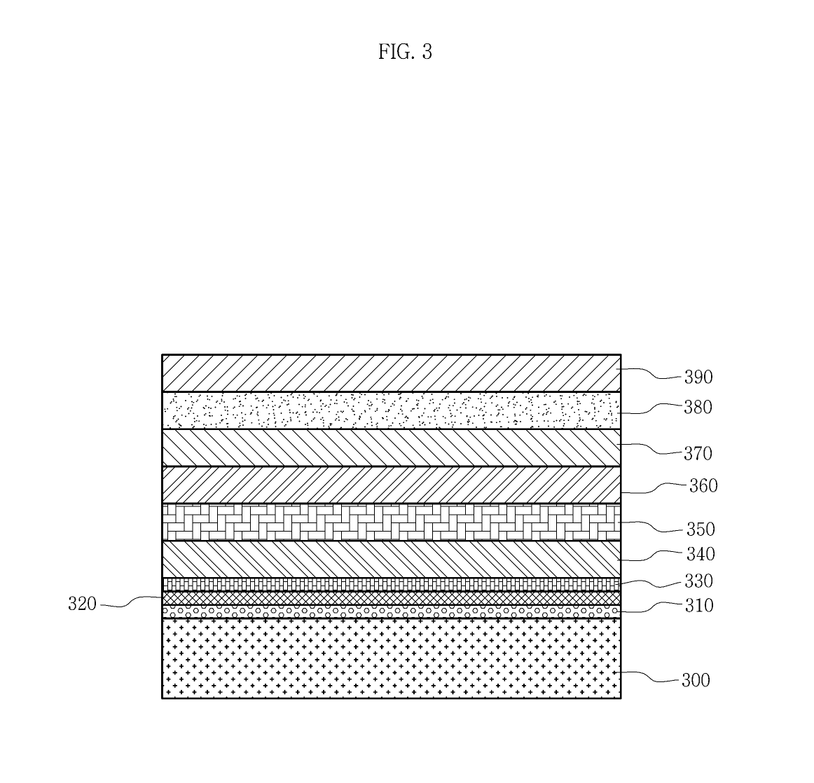

Referring to FIG. 2(b), an anode current collector 220 is deposited on the substrate 200. For example, the anode current collector 220 may be deposited by means of DC magnetron sputtering using a Ni—Cr or Cu target. In FIG. 2(b), the anode current collector 220 is deposited to make a direct contact with the substrate 200. However, as shown in FIG. 3, the anode current collector 380 (see FIG. 3) may also be deposited on an anode active material 370 (see FIG. 3) after the anode active material 370 is deposited.

Referring to FIG. 2(c), a region of the cathode current collector 210 which is to contact an external conducting wire may be masked, and then a cathode active material 230 may be deposited onto the cathode current collector 210 by means of sputtering or the like by using various ceramic targets.

The cathode active material 230 of the cathode may be lithium metal oxide or lithium transition metal oxide. For example, the cathode active material 230 may be at least one selected from the group consisting of LiNi_{0.5}Mn_{1.5}O₄, LiMn₂O₄, M-doped LiMn₂O₄ (M includes a transition metal such as Sn, Co, Fe, Al or the like), Li(MnNiCo)O₂, LiCoO₂ and LiMPO₄ (M is a transition metal), and LiMPO₄ may be LiFePO₄ or LiNiPO₄.

The thickness of the cathode active material 230 deposited at a time is not limited but may be in the range of several ten nanometers top several micrometers. At this time, life span characteristics and charging/discharging characteristics of the fabricated thin film may be adjusted by controlling the type and/or the thickness of the deposited cathode active material 230. The deposited cathode active material 230 has the degree of crystallization close to an amorphous state.

In an embodiment, the cathode active material 230 may be deposited at normal temperature. For example, when the cathode active material 230 is deposited at normal temperature by means of on-axis RF magnetron sputtering, the cathode active material 230 may be deposited and crystallized at relatively low temperature. For this reason, even though a polymer substrate is used, the substrate may not be deformed while the cathode active material 230 is being crystallized. At this time, the normal temperature represents temperature neither heated nor cooled, for example in the range of about −20° C. to 40° C., more preferably in the range of about 5° C. to 35° C.

After the cathode active material 230 is deposited, as shown in FIG. 2(d), light is irradiated to the cathode active material 230 by using laser 240.

In an embodiment, the laser 240 may be excimer laser. For example, a KrF excimer laser source having a wavelength of about 248 nm or an ArF excimer laser source having a wavelength of about 193 nm may be used, without being limited thereto. If laser with a short wavelength is used, the cathode active material may be crystallized by irradiating the laser within a relatively short time.

The energy may be processed by allowing the light emitted from the laser 240 to pass through a homogenizer 241 so that the light may be uniform over a large area. The uniform light may be focused into a laser beam by using a focus lens 242, and the laser beam is irradiated to the cathode active material 230 with an adjusted size and direction.

In an embodiment, light may be instantly irradiated onto the cathode active material 230 in an instant pulse form during several nanoseconds to crystallize the cathode active material 230. Since the light is irradiated to the cathode active material 230 within a short time, the cathode active material 230 may be rapidly crystallized without damaging the substrate 200 which usually happens when heating the cathode active material 230 during an existing cathode crystallizing process.

At least one factor among a frequency of the light irradiated to the cathode active material 230, a pulse number representing the number of irradiation shots of light, energy of the irradiated light and the like may be adjusted. By doing so, it is possible to enhance the crystallinity of the cathode active material 230 or adjust the thin film into an appropriate crystalline state.

After the cathode active material 230 is crystallized, as shown in FIG. 2(e), an electrolyte material is deposited onto the cathode 230 by means of RF magnetron sputtering or the like to form an electrolyte layer 250. The electrolyte layer 250 may be made of ceramic such as LiPON, Li—La—Zn—O, Li—La—Ti—O, (Li,La)TiO₃ (LLTO) or the like in a solid state or gel electrolyte. The electrolyte layer 250 may have a thickness of 800 nm or above to prevent a short circuit of the cathode active material 230 and the anode active material 260.

As shown in FIG. 2(f), an anode active material 260 is deposited onto the electrolyte layer 250. The anode active material 260 is deposited to make a contact with the anode current collector 220. An anode thin film may be formed by means of RF magnetron sputtering, thermal evaporation, etc. The anode film 260 may be made of, for example, Li, Si, Si—Al, LTO, C or the like.

FIG. 3 is a cross-sectional view of a thin film battery according to an embodiment of the present disclosure. Referring to FIG. 3, the thin film battery may include a substrate 300, a cathode current collector 340, a cathode 350, an electrolyte layer 360, an anode 370 and an anode current collector 380. The cathode 350 may be fabricated by the method of fabricating a cathode for a thin film battery according to an embodiment of the present disclosure.

The thin film battery is a flexible battery, and even though the cathode formed on the substrate is crystallized by laser, the heat high enough to deform the polymer material is not transferred to the substrate. Therefore, the substrate may be made of polymer material.

In addition, as shown in FIG. 3, one surface of the cathode current collector 340 may make a direct contact with one surface of the cathode 350. In an embodiment of the present disclosure, since the cathode 350 is crystallized using laser, the cathode active material may be instantly crystallized using laser while being deposited onto the substrate 300 made of polymer. Therefore, any adhesion layer is not required between the cathode current collector 340 and the cathode 350, and the cathode 350 may be directly formed on one surface of the cathode current collector 340.

Even though FIG. 3 shows that the substrate 300, the cathode 350 and the anode 370 are stacked in order in the thin film battery, layers such as the substrate 300, the cathode 350 and the anode 370 may be stacked in another order as necessary in the thin film battery depending on a design of the battery. For example, these layers may be stacked in the order of a substrate, an anode and a cathode.

The thin film battery may further include at least one of buffer layers 310, 320 and an interface adhesion layer 330 between the substrate 300 and the cathode 350, more exactly between the substrate 300 and the cathode current collector 340. The buffer layers 310, 320 may include a silicon nitride layer 310 with high thermal short resistance or a silicon oxide layer 320 with a low thermal diffusion rate.

In addition, the thin film battery may further include a barrier film layer 390 on the anode thin film. The barrier film layer 390 is formed at an outermost side of the thin film battery to prevent oxidation of the film.

Hereinafter, detailed examples will be presented for better understanding of the present disclosure. However, the following examples are for describing the present disclosure, and the present disclosure is not limited thereto.

### EXAMPLES

### Fabrication of a Cathode

### Example 1

A silicon nitride film and a silicon oxide film were deposited on a polymer substrate as buffer layers. Titanium (Ti) was deposited thereon to enhance adhesion, and then platinum (Pt) was deposited thereon in a thickness of 200 nm as a cathode current collector. An upper portion of the cathode current collector to which an external conducting wire is to be connected was masked, and then LiNi_{0.5}Mn_{1.5}O₄ serving as a cathode active material was deposited in a thickness of 280 nm by means of magnetron sputtering with an RF power of 50 W. The distance from a target to the substrate was fixed to be 5 cm. If an initial pressure of a chamber reached 5×10⁻⁶ Torr or below, the deposition was performed by adjusting the pressure to 10×10⁻³ Torr under the condition of Ar:O₂=3:1. The cathode film deposited to the substrate was crystallized at normal temperature by means of excimer laser annealing using a KrF source.

### Fabrication of a Thin Film Battery

### Example 2

LiPON as an electrolyte was deposited on the cathode film prepared in Example 1. The LiPON electrolyte was deposited in a thickness of 800 nm in an N₂ atmosphere by means of RF magnetron sputtering by using a Li₃PO₄ target. The distance from a target to the substrate was fixed to be 7 cm. If an initial pressure of a chamber reached 5×10⁻⁶ Torr or below, the deposition was performed with an RF power of 60 W by adjusting the pressure to 20×10⁻³ Torr under the condition of Ar:O₂=3:1. After the electrolyte was deposited, Ni—Cr serving as an anode current collector was deposited by means of DC magnetron sputtering, and lithium (Li) metal to be used as an anode active material was deposited by means of thermal evaporation.

### Fabrication of a Cathode

### Example 3

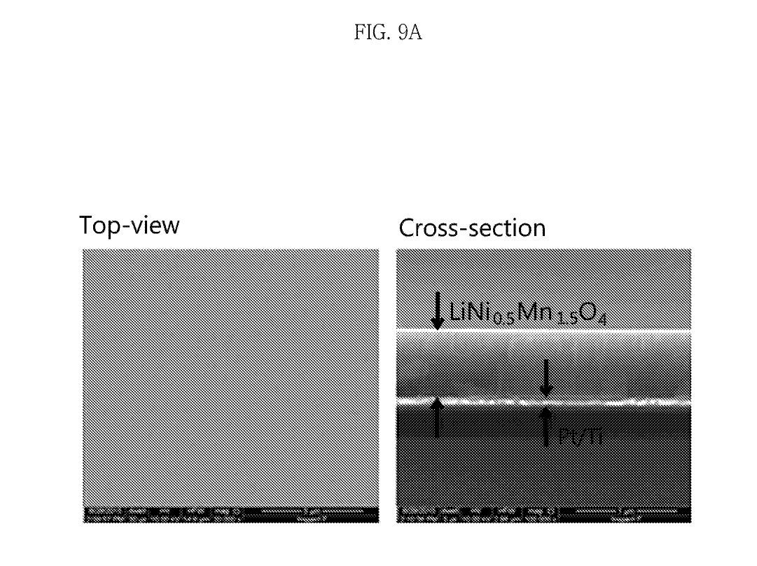

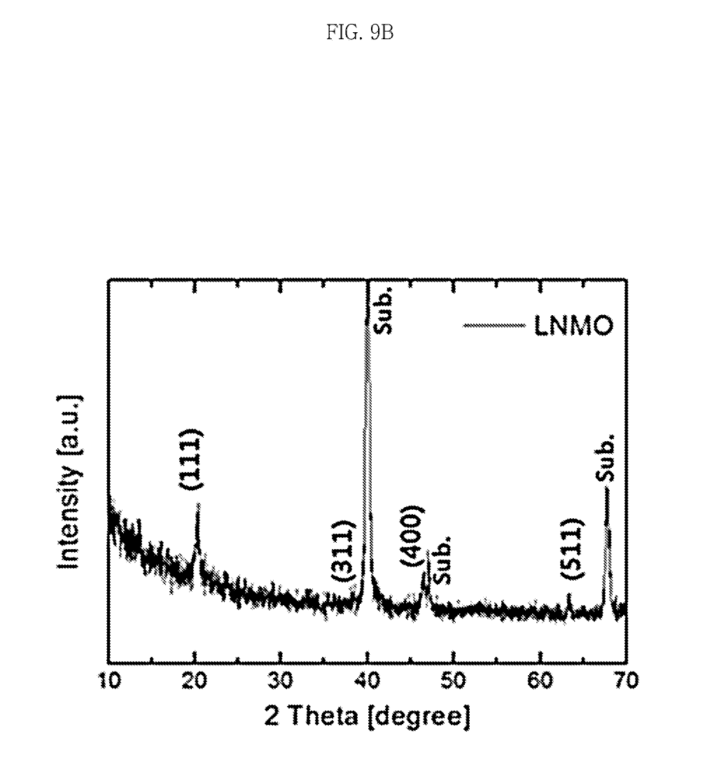

A silicon oxide film was deposited on a silicon substrate as a buffer layer. A titanium layer was deposited thereon to enhance adhesion, and then platinum (Pt) was deposited thereon as a cathode current collector. LiNi_{0.5}Mn_{1.5}O₄ serving as a cathode active material was deposited with a thickness of 650 nm to form a cathode. 1000 shots of an excimer laser (KrF) with an energy of 200 were irradiated onto the cathode layer. The photograph of a scanning electron microscope of the cathode of the present example is illustrated in FIG. 9a.

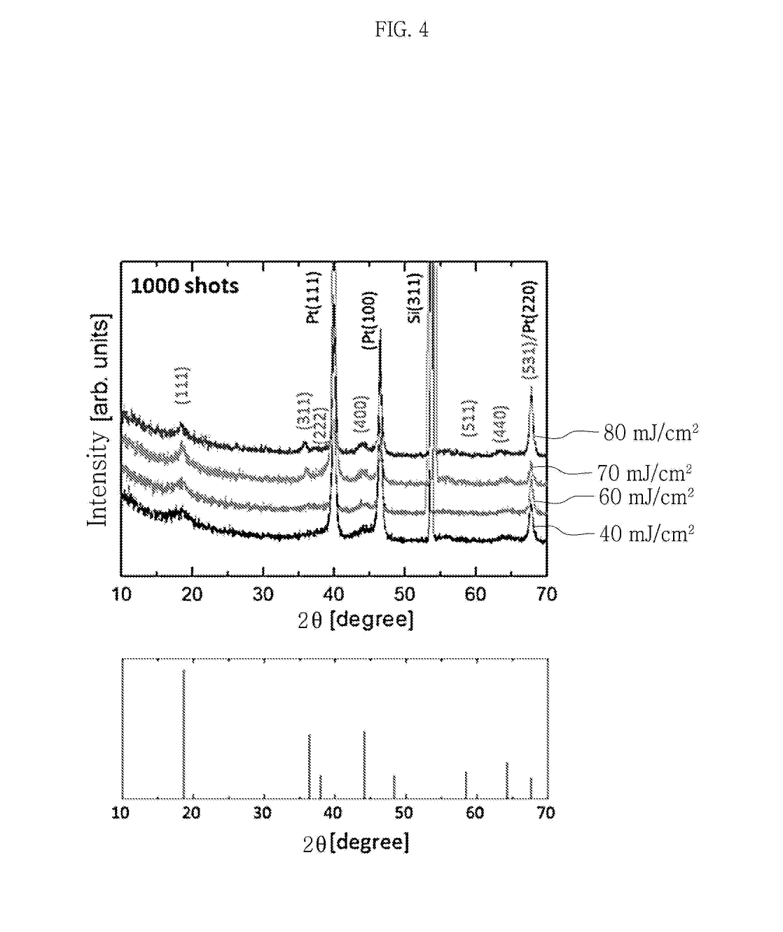

FIG. 4 is a graph showing an X-ray diffraction pattern of the cathode prepared according to Example 1, depending on laser energy. With the laser irradiation shot number being fixed to 1000 shots, laser energy was changed in the range of 0 to 100 mJ/cm².

From the lower graph of FIG. 4, it can be found that a main peak of LiNi_{0.5}Mn_{1.5}O₄ serving as a cathode active material is (111) peak. Also, from the upper graph, it can be found that in case of a film crystallized at low temperature with a relatively low energy of 40 mJ/cm², (111) peak serving as a main peak is wide and somewhat low crystallinity is exhibited. However, as the laser energy is increased, the main peak of the cathode film is gradually clearly exhibited while forming a spinel structure.

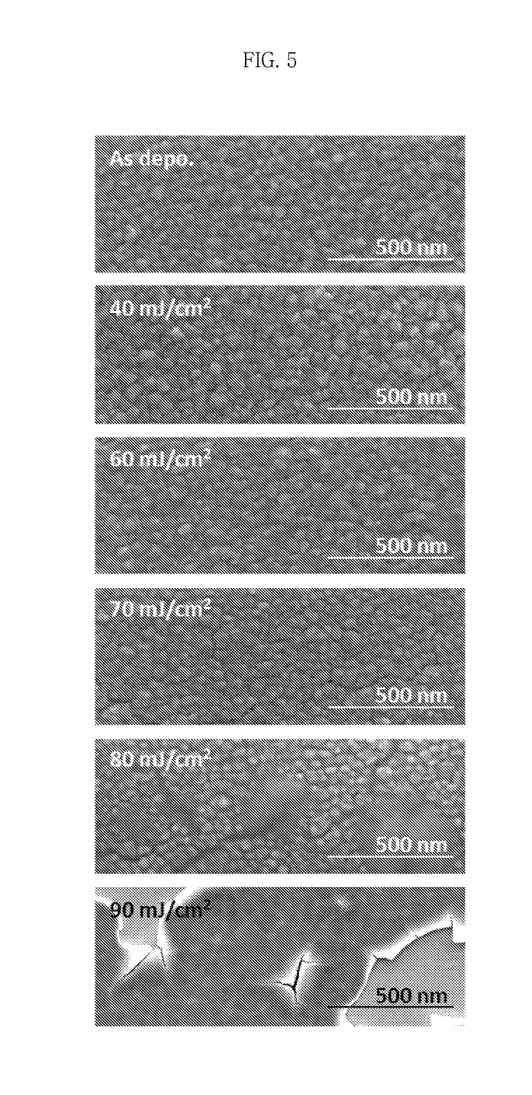

FIG. 5 is a photograph of a scanning electron microscope of the cathode of FIG. 4. The first photograph (As Depo) of FIG. 5 is a scanning electron microscope photograph showing a deposited cathode active material to which laser is not yet irradiated.

Referring to FIG. 5, if the irradiated light has energy of 70 mJ/cm² or below, even though the laser is irradiated, a grain size on the surface of the film is maintained constantly. However, if energy of 80 mJ/cm² is applied, a crack or a melting region is created at the film. In addition, if the laser energy is 90 mJ/cm² or above, debonding behavior of the cathode film is observed.

Therefore, in an embodiment, light having energy of 0 to 80 mJ/cm² may be irradiated to crystallize the cathode active material. By doing so, while the cathode film is being crystallized at low temperature, a crack or a melting region may not be created.

In one embodiment, light having energy of 0 to 200 mJ/cm² may be irradiated to crystallize the cathode active material. FIG. 9b shows X-ray diffraction pattern of the cathode prepared according to Example 3. Referring to FIG. 9b, LiNi_{0.5}Mn_{1.5}O₄ cathode thin layer is crystallized without debonding when the excimer laser has an energy of 200 mJ/cm². Meanwhile, when the excimer laser of more than 200 mJ/cm² is irradiated onto the same cathode, the surface of the thin layer is damaged and the cathode is not crystallized.

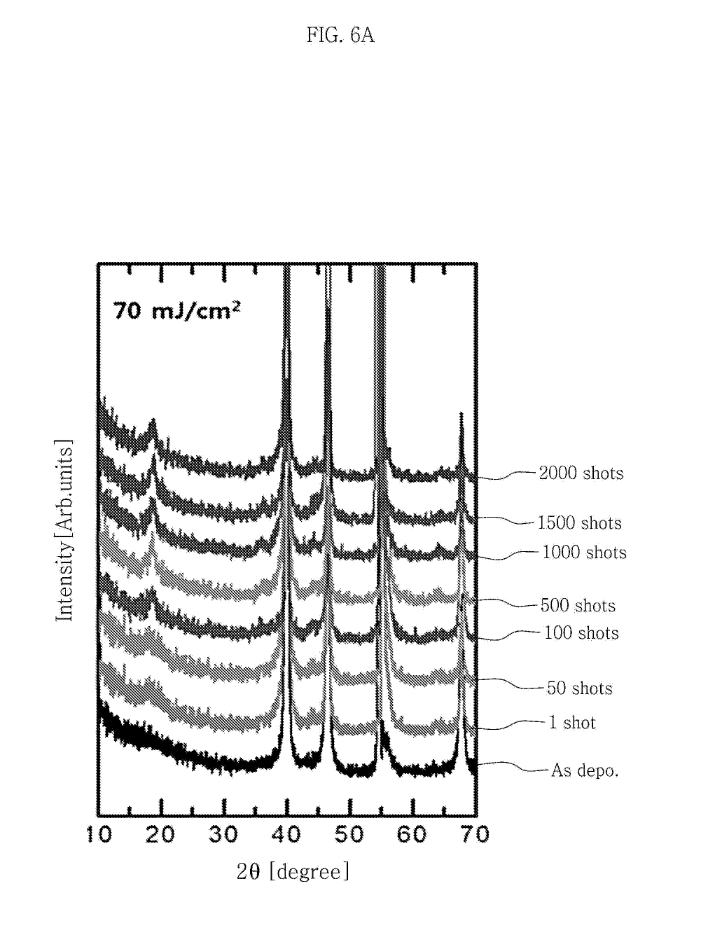

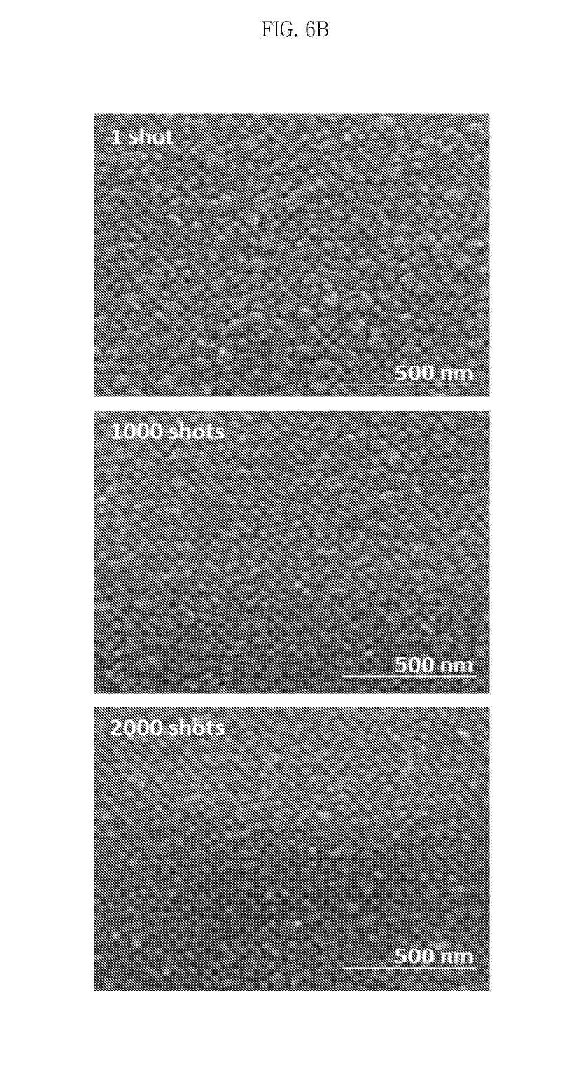

FIG. 6a shows an X-ray diffraction pattern of the cathode prepared by Example 1 depending on a laser irradiation shot number. FIG. 6b is a photograph of a differential scanning microscope of the cathode prepared by Example 1 depending on a laser irradiation shot number. The laser energy was fixed to be 70 mJ/cm², and the laser irradiation shot number was changed in the range of 0 to 2000 shots.

Referring to FIG. 6a, if the laser irradiation shot number is 500 shots or above, a main peak of the cathode film appears and a spinel structure is formed.

In addition, from the differential scanning microscope photograph depicted in FIG. 6b, it can be found that the grain size on the film surface is maintained constantly regardless of the laser irradiation shot number and a crack or a melting region is not created.

Therefore, in an embodiment, the cathode may be crystallized by irradiating light as many as 1 shot to 2000 shots. The light irradiation shot number for crystallizing a cathode may vary depending on the material of the cathode, and if the light irradiation shot number is excessively increased, the cathode film may be cracked or burned.

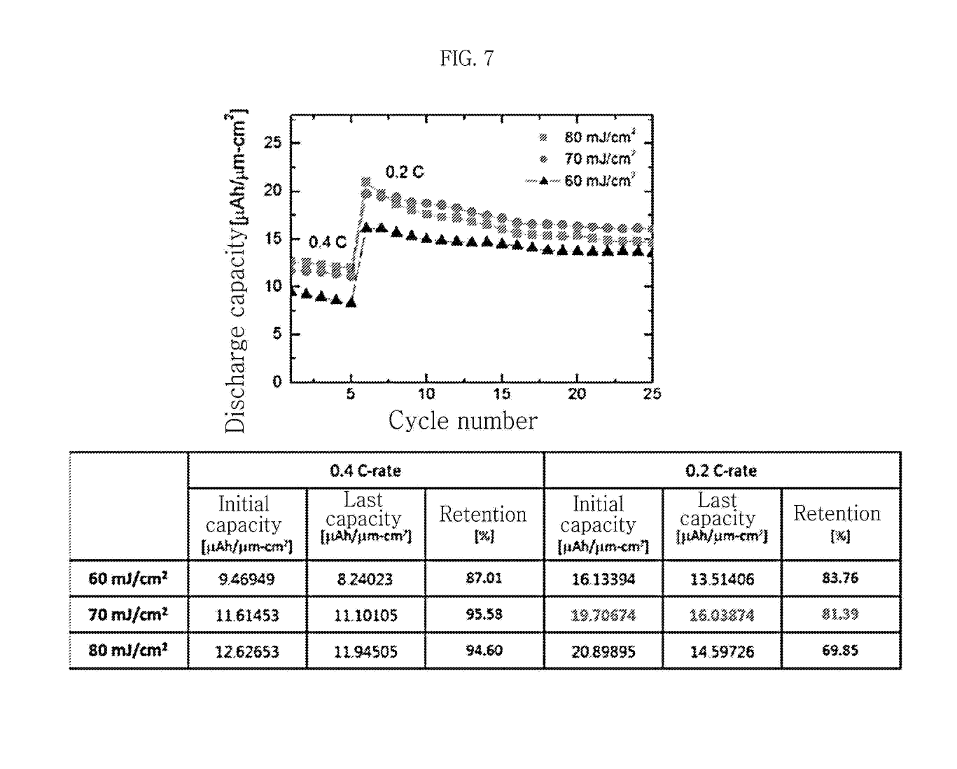

FIG. 7 shows a table and a graph showing electrochemical characteristics of the thin film battery prepared by Example 1, depending on laser energy. A thin film battery was put into a globe box, and its capacity was measured in a potential range of 3.0V to 4.9 V in a galvanic charging/discharging pattern.

Referring to FIG. 7, an initial capacity of the film increases as the laser has a larger energy. However, the capacity retention is excellent at 70 mJ/cm² even though the initial capacity is somewhat low.

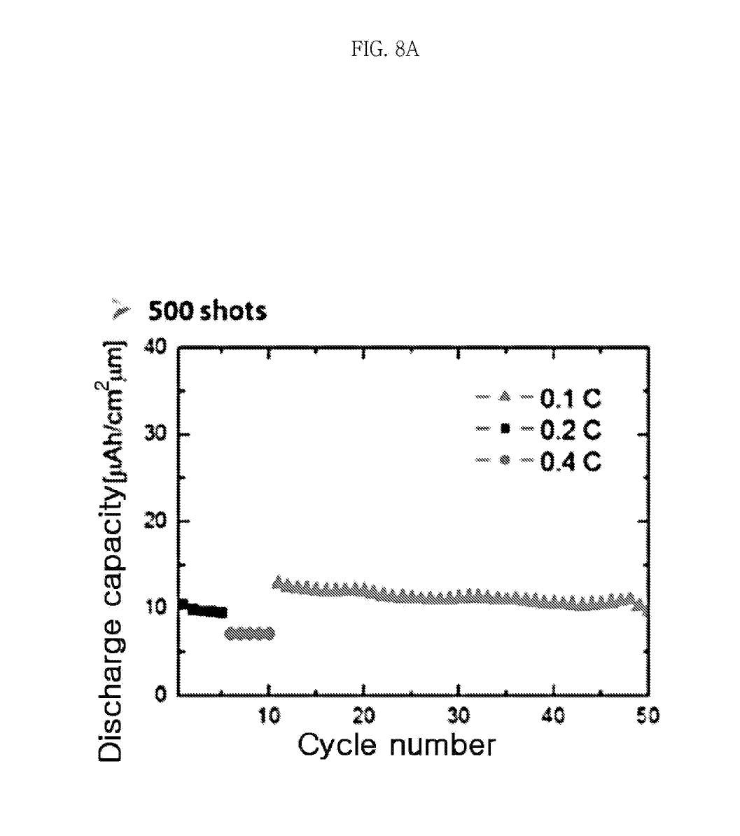

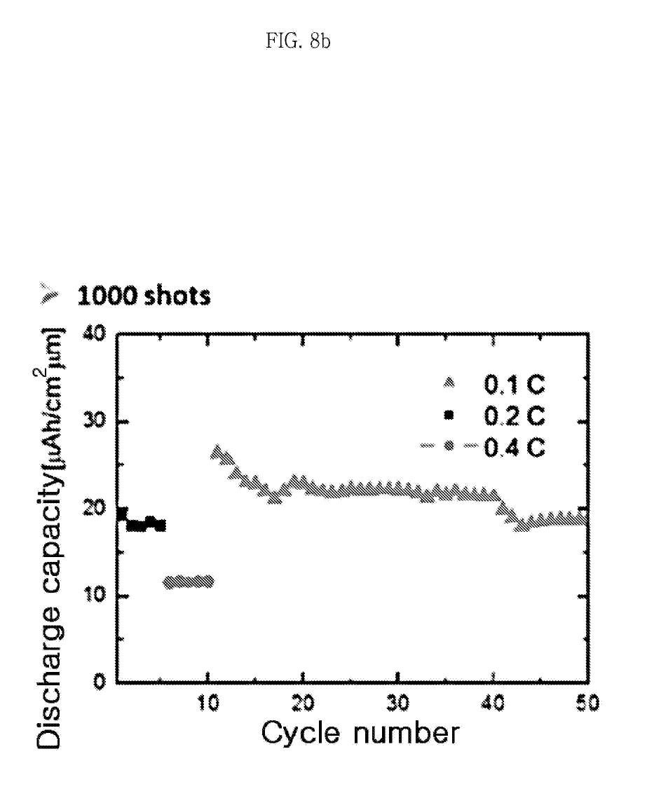

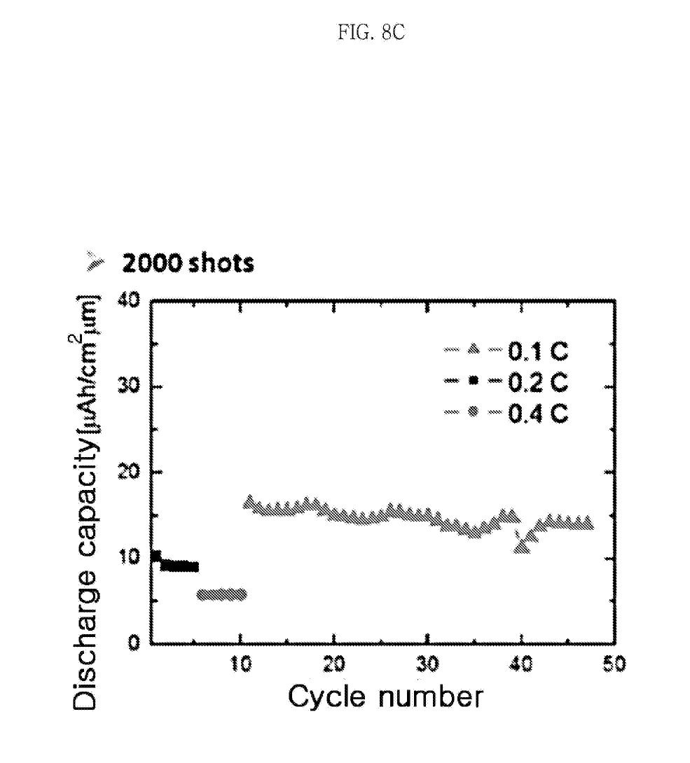

FIGS. 8a to 8c are graphs showing electrochemical characteristics of the thin film battery prepared by Example 2, depending on a laser irradiation shot number. The laser energy was fixed to be 70 mJ/cm², and the laser was irradiated as many as 500 shots in FIG. 8a, 1000 shots in FIG. 8b, and 2000 shots in FIG. 8c.

Referring to FIGS. 8a to 8c, it can be found that at 70 mJ/cm², the capacity characteristic is higher when the laser is irradiated as many as 1000 shots, compared to the cases where the laser is irradiated as many as 500 shots or 2000 shots. In other words, by crystallizing a cathode film on the polymer substrate with low thermal resistance by using laser, it is possible to fabricate a flexible battery for example with a discharge capacity of about 25 μAh/μm·cm² or above and an operating voltage of 4V or above at 0.1 C-rate.

While the exemplary embodiments have been shown and described, it will be understood by those skilled in the art that various changes in form and details may be made thereto without departing from the spirit and scope of the present disclosure as defined by the appended claims. In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method of fabricating a cathode for a thin film battery, comprising:
depositing a cathode active material on a substrate; and
crystallizing the cathode active material by irradiating laser onto the cathode active material.

2. The method of fabricating a cathode for a thin film battery according to claim 1,
wherein the laser is excimer laser.

3. The method of fabricating a cathode for a thin film battery according to claim 2,
wherein the excimer laser uses a KrF or ArF source.

4. The method of fabricating a cathode for a thin film battery according to claim 1,
wherein in said depositing of the cathode active material onto the substrate, the cathode active material is deposited at normal temperature.

5. The method of fabricating a cathode for a thin film battery according to claim 1,
wherein the substrate is a metallic substrate, a polymer substrate or a ceramic substrate.

6. The method of fabricating a cathode for a thin film battery according to claim 1,
wherein said crystallizing of the cathode active material by irradiating laser onto the cathode active material includes irradiating light to the cathode active material during several nanoseconds.

7. The method of fabricating a cathode for a thin film battery according to claim 1,
wherein said crystallizing of the cathode active material by irradiating laser onto the cathode active material includes irradiating light having an energy equal to or greater than 1 mJ/cm² and smaller than 200 mJ/cm² to the cathode active material.

8. The method of fabricating a cathode for a thin film battery according to claim 1,
wherein said crystallizing of the cathode active material by irradiating laser onto the cathode active material includes irradiating light to the cathode active material as many as 1 to 2000 shots.

9. The method of fabricating a cathode for a thin film battery according to claim 8,
wherein the laser is excimer laser using a KrF source, and
wherein said crystallizing of the cathode active material by irradiating laser onto the cathode active material includes irradiating light to the cathode active material as many as 500 to 2000 shots.

10. The method of fabricating a cathode for a thin film battery according to claim 1, before said depositing of the cathode active material onto the substrate, further comprising:
forming a buffer layer on the substrate.

11. The method of fabricating a cathode for a thin film battery according to claim 10,
wherein the buffer layer is made of silicon nitride or silicon oxide.

12. The method of fabricating a cathode for a thin film battery according to claim 1, before said depositing of the cathode active material onto the substrate, further comprising:
depositing a cathode current collector on the substrate.

13. The method of fabricating a cathode for a thin film battery according to claim 1,
wherein the cathode active material is at least one selected from the group consisting of LiNi_{0.5}Mn_{1.5}O₄, LiMn₂O₄, M-doped LiMn₂O₄, Li(MnNiCo)O₂, LiCoO₂ and LiMPO₄ (M is a transition metal).

14. The method of fabricating a cathode for a thin film battery according to claim 1,
wherein in said depositing of the cathode active material onto the substrate, the cathode active material is deposited as thick as several ten nanometers to several micrometers.

15. A thin film battery, comprising:
a substrate;
a cathode current collector formed on the substrate;
a cathode formed on the cathode current collector;
an electrolyte layer formed on the cathode; and
an anode formed on the electrolyte layer,
wherein the substrate is made of polymer material.

16. The thin film battery according to claim 15,
wherein one surface of the cathode is in direct contact with one surface of the cathode current collector.

17. The thin film battery according to claim 15, further comprising:
a buffer layer formed between the substrate and the cathode.

18. The thin film battery according to claim 17,
wherein the buffer layer serves as a thermal cutoff layer for preventing a heat transfer from the cathode to the substrate.

19. The thin film battery according to claim 17,
wherein the buffer layer is made of silicon nitride or silicon oxide.

20. The thin film battery according to claim 15, further comprising:
an electrolyte layer formed between the cathode and the anode.

21. The thin film battery according to claim 15, further comprising:
a barrier film layer formed on the anode to prevent oxidation of the thin film battery.
